(19) United States
(12) Patent Application Publication
(10) Pub. No.: US 2025/0350149 A1
(43) Pub. Date: Nov. 13, 2025

(54) POWER SUPPLY EXTENSION DEVICE OF NOTEBOOK COMPUTER

(71) Applicant: OXTI Pte Ltd, Singapore (SG)

(72) Inventor: Chih-Feng Ho, Singapore (SG)

(21) Appl. No.: 18/659,019

(22) Filed: May 9, 2024

(51) Int. Cl. H02J 50/10; G06F 1/16; H01M 10/46

(52) U.S. Cl. CPC H02J 50/10; G06F 1/1635; H01M 10/46; H01M 2220/30

(57) ABSTRACT

A power supply extension device of notebook computer includes: a notebook computer, which includes a detection device; a wireless charging device, which is arranged on the notebook computer; and a solid state battery, which is electrically connected with the wireless charging device. A user may place the detection device of the notebook computer to contact with the wireless charging device, with the wireless charging device being electrically connected with the solid state battery, the detection device being provided with a second coil induction module and the wireless charging device being provided with a first coil induction module to couple with each other so as to have the notebook computer wirelessly charged with the electrical power of the solid state battery.

### BACKGROUND OF THE INVENTION

### (a) Technical Field of the Invention

The present invention relates to a device for elongating supply of power, and more particularly to a power supply extension device of notebook computer.

### (b) Description of the Prior Art

Recently, with the progress of science and technology, the bulky desktop computers that are used traditionally are now simplified and downsized to ones that are easy to carry, such as notebook computers, in order to make the living of people more efficient.

The power consumed for the operation of a notebook computer is supplied from a rechargeable battery, such as a nickel hydrogen battery or a lithium battery. The rechargeable battery is chargeable with an external charging device.

Taiwan Patent I377476 discloses a notebook computer having a host module, a monitor module pivotally mounted to the host module, and a solar energy battery module having a solar panel. The monitor module has an outside surface that is provided with a first connector that is in electrical connection with the host module. The solar energy battery module is provided with a second connector corresponding to the first connector, such that the second connector is connectable with the first connector for removably mounting the solar energy battery module to the monitor module.

However, the prior art uses solar energy as a power source, and this is limited by the weather condition. If the weather condition is poor, charging will be influenced. Thus, further improvement is necessary.

### SUMMARY OF THE INVENTION

In view of the above problems, the present invention aims to resolve and improve the problems and drawbacks of the prior art.

To achieve the above-mentioned objective, the present invention provides a power supply extension device of notebook computer, which comprises: a notebook computer, which comprises a detection device; a wireless charging device, which is arranged on the notebook computer; and a solid state battery, which is electrically connected with the wireless charging device.

The detection device comprises a second coil induction module.

The wireless charging device comprises a power module, a first coil induction module, and a controller, and the power module is electrically connected with the first coil induction module and the controller.

The solid state battery comprises an oxide-series solid state battery, a sulfide-series solid state battery, or a polymer-series solid state battery.

A user may place the detection device of the notebook computer to contact with the wireless charging device, with the wireless charging device being electrically connected with the solid state battery, the detection device being provided with a second coil induction module and the wireless charging device being provided with a first coil induction module to couple with each other so as to have the notebook computer wirelessly charged with the electrical power of the solid state battery.

### BRIEF DESCRIPTION OF THE DRAWINGS

FIG. 1 is a schematic view showing a portion of a power supply extension device of notebook computer according to the present invention.

FIG. 2 is a block diagram of the power supply extension device of notebook computer according to the present invention.

FIG. 3 is a schematic view showing a notebook computer including a detection device according to the present invention.

FIG. 4 is a schematic view showing the power supply extension device of notebook computer according to the present invention.

FIG. 5 is a schematic view showing a use of the power supply extension device of notebook computer according to the present invention.

### DETAILED DESCRIPTION OF THE PREFERRED EMBODIMENTS

For better understanding of the contents of other features and advantages of the present invention, and the efficacy achieved thereby, a detailed description will be provided below with reference to the drawings.

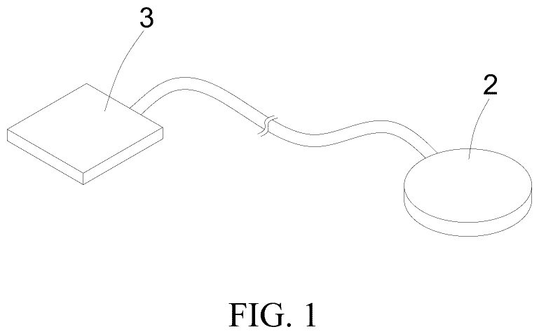

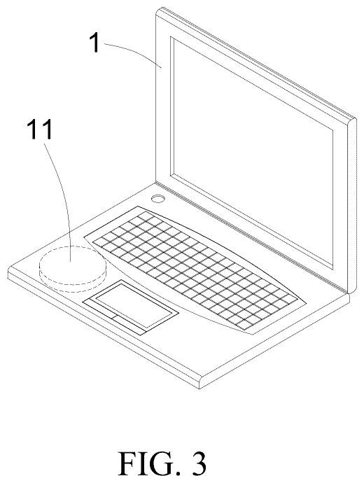

Referring to FIGS. 1, 2, and 3, the present invention provides a power supply extension device of notebook computer, which comprises: a notebook computer 1, a wireless charging device 2, and a solid state battery (SSB) 3.

The notebook computer 1 is provided with a detection device 11. The detection device 11 comprises a second coil induction module 12, and the notebook computer 1 is also provided with a power management unit (PMU) 13 and a battery 14. The power management unit 13 is an integrated circuit and generally comprises multiple power management functions, such as voltage regulation, current monitoring, and battery management. The PMU is responsible for coordinating and managing all sorts of power demands for the notebook computer 1 to stable operation of the notebook computer 1 under all sorts of operation conditions. The battery 14 has an internal structure that mainly includes a battery core and a charging/discharging control circuit board. The battery core is the energy center of the battery, and the battery core is responsible for a charging/discharging operation, while the charging/discharging control circuit board is operated for controlling charging/discharging to/from the battery core in order to enable charging when the battery core runs out of electrical power and to cut off charging when the battery core is fully charged.

The wireless charging device 2 is arranged on the notebook computer 1. The wireless charging device 2 comprises a power module 21, a first coil induction module 22, and a controller 23. The power module 21 is electrically connected with the first coil induction module 22 and the controller 23. The controller 23 comprises a memory that stores a plurality of setting parameters, and the plurality of setting parameters include: a high power charging time, a regular power charging time, and a low power charging time. The controller 23 regulates a transmitting power generated by the power module 21 in response to the high power charging time, the regular power charging time, and the low power charging time. Under a condition that the first coil induction module 22 of the wireless charging device 2 carries out a wireless charging operation to the notebook computer 1, the controller 23 regulates the transmitting power generated by the power module 21, so that the first coil induction module 22, upon receiving the transmitting power, transmits a wireless charging signal having a designated power to the second coil induction module 12 of the notebook computer 1.

The solid state battery 3 is electrically connected to the wireless charging device 2. The solid state battery 3 is electrically connected through a cable to the wireless charging device 2. The solid state battery 3 can be an oxide-series solid state battery, a sulfide-series solid state battery, or a polymer-series solid state battery. The solid state battery 3 uses a solid state electrolyte and thus does not suffer drawbacks such as pollution resulting from leaking and easy explosion, and is characterized by high safety. Due to the safety of the solid state battery, the positive and negative electrodes can be made of materials having higher energy densities to exhibit advantages of higher battery energy storage, faster charging/discharging speed, and smaller and compacter size.

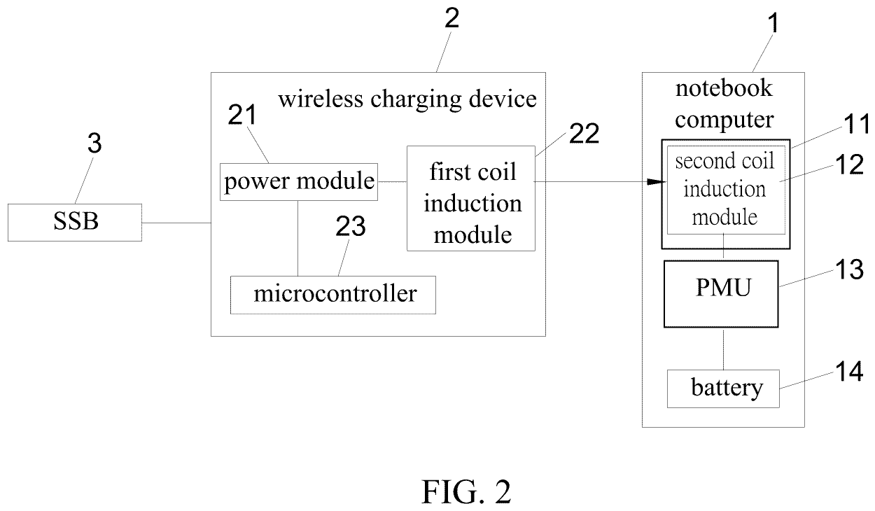

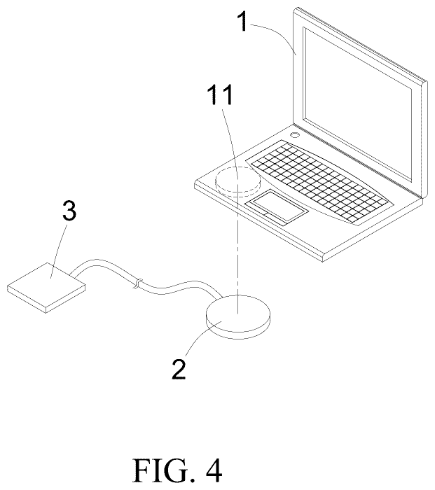

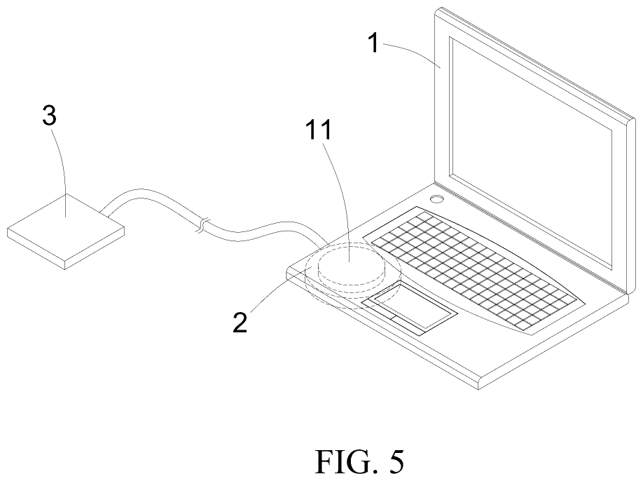

Referring to FIGS. 2, 4, and 5, when a user places the detection device 11 of the notebook computer 1 to contact with the wireless charging device 2, magnetic flux is induced between the second coil induction module 12 of the detection device 11 and the first coil induction module 22 of the wireless charging device 2, and meanwhile, the first coil induction module 22, the second coil induction module 12, and the power management unit 13 start wireless charging to the battery 14 of the notebook computer 1. When the electrical power capacity of the battery 14 is charged to 100%, the power management unit 13 stops the charging operation to the battery 14.

As such, the user may place the detection device 11 of the notebook computer 1 to contact with the wireless charging device 2, with the wireless charging device 2 being electrically connected with the solid state battery 3, the detection device 11 being provided with a second coil induction module 12 and the wireless charging device 2 being provided with a first coil induction module 22 to couple with each other so as to have the notebook computer 1 wirelessly charged with the electrical power of the solid state battery 3.

I claim:

1. A power supply extension device of notebook computer, comprising:
a notebook computer, which comprises a detection device;
a wireless charging device, which is arranged on the notebook computer; and
a solid state battery, which is electrically connected with the wireless charging device.

2. The power supply extension device of notebook computer according to claim 1, wherein the detection device comprises a second coil induction module.

3. The power supply extension device of notebook computer according to claim 1, wherein the wireless charging device comprises a power module, a first coil induction module, and a controller, and the power module is electrically connected with the first coil induction module and the controller.

4. The power supply extension device of notebook computer according to claim 1, wherein the solid state battery comprises an oxide-series solid state battery, a sulfide-series solid state battery, or a polymer-series solid state battery.
